(19) United States
(12) Patent Application Publication
(10) Pub. No.: US 2005/0104846 A1
(43) Pub. Date: May 19, 2005

(54) Apparatus, system, and process for demarking control objects using direct non-visible light

(76) Inventors: Ravi Shankarnarayan Adapathya, Durham, NC (US); Joel Wyman Collins III, Raleigh, NC (US); David Wayne Hill, Cary, NC (US); Aaron Michael Stewart, Raleigh, NC (US)

Correspondence Address: KUNZLER & ASSOCIATES, 8 EAST BROADWAY, SUITE 600, SALT LAKE CITY, UT, 84111, US

(21) Appl. No.: 10/717,097

(22) Filed: Nov. 19, 2003

(51) Int. Cl. G09G 5/00

(52) U.S. Cl. 345/156

(57) ABSTRACT

An apparatus, system, and process for demarking a control object using direct non-visible light is disclosed. A non-visible light reactive compound is applied to the control object. In one embodiment, the non-visible light reactive compound forms a designator. A non-visible light source directly radiates the non-visible light reactive compound. The non-visible light reactive compound reacts to the non-visible light by radiating visible light, illuminating the non-visible light reactive compound. The illuminated non-visible light reactive compound demarks the control object. In one embodiment, the non-visible light source is an ultraviolet light source and the non-visible light reactive compound is an ultraviolet reactive compound.

### BACKGROUND OF THE INVENTION

1. Field of the Invention

This invention relates to illuminating input/output devices and more particularly relates to demarking control objects with non-visible light.

2. Description of the Related Art

Input/output (“I/O”) devices such as computer keyboards, notebook computers, personal digital assistants, telephones, and wireless email devices are often used in low-light environments. In a low-light environment there is generally insufficient light for a user to distinctly identify a control object or a designator affixed to the control object of an I/O device. The designator may be a symbol such as a letter of the alphabet imprinted or formed upon the control object.

The control objects of I/O devices frequently must be identified in low-light environments. For example, when a user chooses to be in the low-light environment, such as a darkened airplane cabin or a darkened taxi, the user may still need to use an I/O device. Indeed, the user may also choose to work in a low-light environment for any number of reasons. For example, many computer users prefer to work in a darkened room.

Identifying the control object of the I/O device, such as a key on a keyboard, is difficult in a low-light environment. The designators of control objects are also often unidentifiable in a low-light environment. The position of control objects may also be difficult to identify. In attempts to remedy this situation, users frequently illuminate the control objects in low-light environments in order to identify the control object and the N designator of the control object. For example, visible direct light sources (“VDLS”) have been positioned to directly illuminate control objects on I/O devices.

FIG. 1 illustrates a notebook computer with an integrated VDLS 100 of the current practice. The VDLS notebook computer 100 is one example of illuminating the control objects of an I/O device with direct visible light. The VDLS notebook computer 100 includes a VDLS 105 and one or more keys or control objects 110. For simplicity, only the referenced control objects 110 are annotated.

The control object 110 is positioned on the VDLS notebook computer 100. A designator such as a letter of the alphabet may be imprinted on the control object 110. The VDLS 105 is an integral part of the VDLS notebook computer 100. When activated, the VDLS 105 illuminates the control object 110, enabling a user to identify the control object 110 in a low-light environment.

Unfortunately, the VDLS 105 typically illuminates multiple control objects 110 with an unequal distribution of light. The control object 110a near the edge of the VDLS notebook computer 100 receives significantly less light than the control object 110b nearer the center of the keyboard and the VDLS 105. If the intensity of the VDLS 105 is increased to provide sufficient illumination for the control object 110a near the edge, the intensity of illumination at the control object 110b near the VDLS 105 may be excessive. Excessive illumination of the control object 110b may cause glare and obscure the designator of the control object 110b. Although the VDLS 105 enables a user to identify the control object 110 in a low-light environment, one or more control objects 110 may not be easily identifiable because of the unequal distribution of light and because of glare.

FIG. 2 illustrates a VDLS system 200 of the current practice. The VDLS system 200 includes an I/O device 205, a positioning stalk 210, and a VDLS 215. The I/O device 205 includes one or more control objects 110 and a display 225. The positioning stalk 210 positions the VDLS 215 relative to the I/O device 205. The VDLS 215 illuminates the control objects 110, enabling the user to identify the control object 110 in a low-light environment.

Unfortunately, if the VDLS 215 has sufficient intensity to illuminate the control object 110 of the I/O device 205, the VDLS 215 may also distract the user and people near the user. The VDLS 215 may also diminish the contrast of the display 225, increase the drain on a battery, and reduce the overall portability of the system.

To reduce the unequal distribution of light that occurs when attempting to illuminate widely separated control objects 110, visible light sources (“VLS”) have been installed to backlight the control objects 110. A backlight VLS illuminates the control object 110 from the plane of the control object 110 or from behind the plane of the control object 110. The backlight VLS also may function as a control delineator, demarking a control area containing one or more control objects 110.

FIG. 3 illustrates a backlight control area 300 of the current practice. The backlight control area 300 includes a control panel 305, a backlight VLS control delineator 310, and one or more control objects 110. The backlight VLS control delineator 310 illuminates the control object 110. In addition, the backlight VLS control delineator 310 demarks the location of the control object 110 by outlining the control object 110 on the control panel 305. The backlight VLS control delineator 310 may reduce the intensity of the VLS needed to illuminate the control objects 110 and reduce the distraction to the user and to nearby people. Unfortunately, installing the backlight VLS control delineator 310 is often more expensive than employing the VDLS 105 of FIG. 1. Backlighting typically requires multiple VLSs and multiple backlight VLS control delineators 310 installed in the backlight control area 300.

FIG. 4 illustrates a backlight VLS illuminated control object 400 of the current practice. The backlight VLS illuminated control object 400 internally illuminates a designator 405 of a control object 110. The backlight VLS illuminated control object 400 includes a control object 110 and a designator 405. The designator 405 is a translucent material. The backlight VLS illuminated control object 400 backlights the control object 110 designator 405.

The backlight VLS illuminated control object 400 illuminates the designator 405 with a minimum of glare. The designators 405 of one or more VLS illuminated control objects 400 are typically uniformly illuminated, and the illumination is less distracting to nearby people or to the user than the VDLS 105 of FIG. 1. Unfortunately, illuminating the backlight VLS illuminated control object 400 and imbedding the translucent designator 405 in the backlight VLS illuminated control object 400 is expensive, particularly for an I/O device 205 with multiple control objects 110 such as a keyboard.

What is needed is a process, apparatus, and system that demarks one or more control objects 110 in a low-light environment with a uniform illumination for each control object 110, with reduced glare, and with reduced degradation of display contrast. What is further needed is a process, apparatus, and system for cost effective illumination of the control object 110. Beneficially, such a process, apparatus, and system would enable a user to employ an I/O device 205 such as a notebook computer or personal digital assistant in a low-light environment with reduced distraction to nearby people and to the user from the light source.

### BRIEF SUMMARY OF THE INVENTION

The present invention has been developed in response to the present state of the art, and in particular, in response to the problems and needs in the art that have not yet been fully solved by currently available apparatus, systems and processes for illuminating the control objects 110 of input/output (“I/O”) devices. Accordingly, the present invention has been developed to provide a process, apparatus, and system for demarking a control object 110 in a low-light environment that overcome many or all of the above-discussed shortcomings in the art.

The apparatus for demarking a control object 110 is provided with components configured to functionally execute the necessary steps of directly radiating a non-visible light reactive compound (“NVLRC”) applied to a control object 110 with a non-visible light source (“NVLS”). These components in the described embodiments include a NVLRC and a NVLS.

The NVLRC is applied to a control object. In one embodiment, the NVLRC is combined with the control object's 110 visible designator. In an alternate embodiment, the NVLRC is applied in a designator pattern different from the pattern of control object's 110 visible designator. In an alternate embodiment, the NVLRC is applied in such a manner as to function as a control delineator, thereby demarking a control area containing one or more control objects 110.

The NVLS directly radiates the NVLRC with non-visible light. In one embodiment, the NVLS is an ultraviolet light source. The NVLRC may be an ultraviolet reactive compound. In a certain embodiment, the NVLS is an ultraviolet light emitting diode. The NVLRC reacts to the NVLS by radiating visible light. The visible light radiated from the NVLRC demarks the control object 110. In a certain embodiment, the visible light from the NVLRC forms the designator of the control object 110.

The demarcation provided by the visible light emitted by the NVLRC of each control object 110 appears to the user to have a more uniform illumination and reduced glare than a control object 110 illuminated by direct visible light. In addition, the contrast between the illuminated NVLRC and the I/O device is high, while the visible light that may distract the user and nearby people is low. The present invention clearly demarks the control object 110 in a low-light environment without the distractions of direct visible light source illumination.

A system of the present invention is also presented for demarking a control object 110 in a low-light environment. In particular, the system, in one embodiment, includes an I/O device, and a NVLS. The I/O device includes a control object 110 and a NVLRC.

The NVLRC is applied to the control object 110. The NVLS directly radiates the NVLRC, activating the NVLRC. The NVLRC radiates visible light demarking the control object 110. The contrast between the NVLRC radiated visible light and the I/O device is high. The NVLRC radiated visible light does not substantially reduce the I/O device display contrast.

The NVLS in one embodiment is configured as a display. The display may radiate non-visible light wavelengths to radiate the NVLRC in addition to radiating visible light wavelengths. In an alternate embodiment, the NVLS is separate from the I/O device. The NVLS may also be connected to the I/O device with a positioning stalk.

A process of the present invention is also presented for demarking a control object in a low-light environment. The process in the disclosed embodiments substantially includes the steps necessary to carry out the functions presented above with respect to the operation of the described apparatus and system.

In one embodiment, the process includes applying a NVLRC to a control object. In one embodiment, the NVLRC forms a designator for the control object. The process further includes directly radiating the NVLRC with a NVLS. The NVLS activates the NVLRC and the NVLRC radiates visible light, demarking the control object.

The present invention demarks one or more control objects 110 in a low-light environment in a uniform manner. In addition, the present invention reduces the glare and increases the contrast and effective brightness of the NVLRC applied to the control object 110. The present invention also reduces the distraction to the user and to nearby people from demarking the control object 110. These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 illustrates a notebook computer with an integrated visible direct light source of the current practice;

FIG. 2 illustrates a visible direct light source system of the current practice;

FIG. 3 illustrates a backlight control area of the current practice;

FIG. 4 illustrates a backlight visible light source illuminated control object of the current practice;

FIG. 5 depicts one embodiment of a non-visible-light-demarking system of the present invention;

FIG. 6 depicts one embodiment of a non-visible-light-demarking device of the present invention;

FIG. 7 illustrates one embodiment of a movable non-visible light source of the present invention

FIG. 8 depicts one embodiment of a non-visible light source display in accordance with the present invention;

FIG. 9 illustrates one embodiment of a control area control delineator of the present invention; and

FIG. 10 is a flow chart diagram illustrating one embodiment of a non-visible light demarking process in accordance with the present invention.

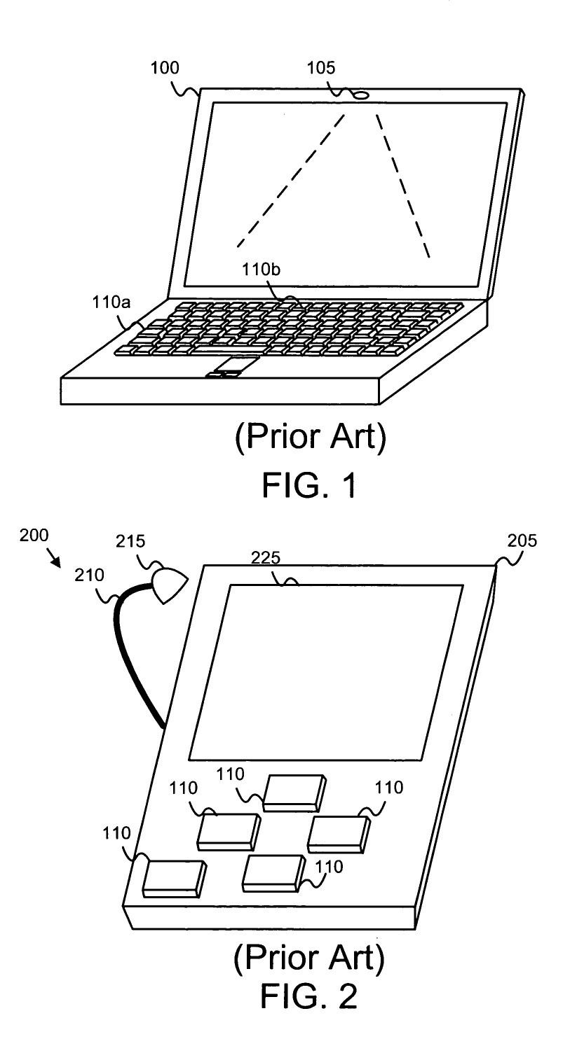

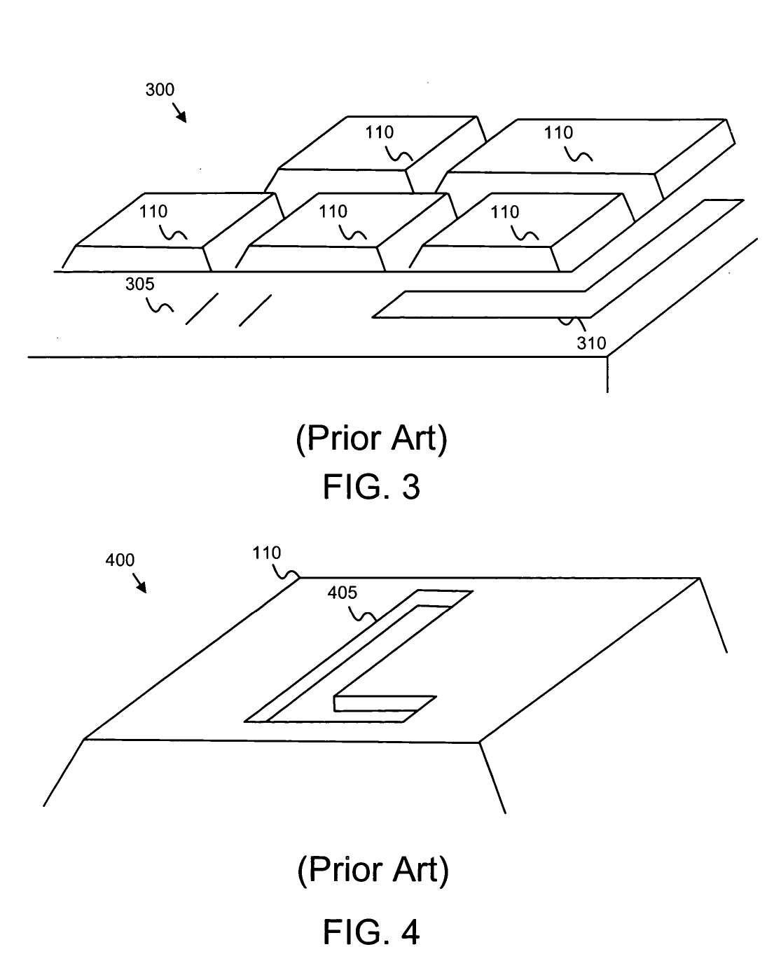

### DETAILED DESCRIPTION OF THE INVENTION

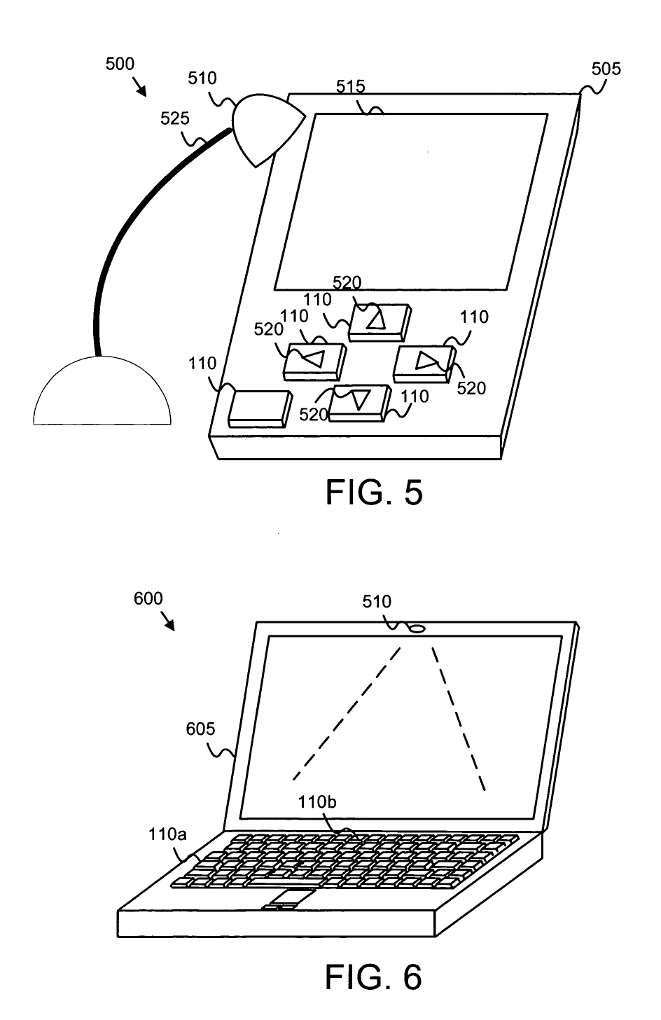

FIG. 5 depicts one embodiment of anon-visible-light-demarking system 500 of the present invention. The non-visible-light-demarking system 500 demarks a control object 110 by radiating a non-visible light reactive compound (“NVLRC”) with a direct non-visible light source (“NVLS”). The non-visible-light-demarking system 500 includes an input/output (“I/O”) device 505, a display 515, one or more control objects 110, one or more designators 520, a NVLS 510, and a NLVS mount 525.

The control object 110 resides on the I/O device 505. A NVLRC is applied to the control object 110. The NVLRC may be mixed with an adhesive compound and applied to the control object 110. In a certain embodiment, the NVLRC is bonded to a matrix material and the matrix material is adhered to the control object 110. In one embodiment, the NVLRC forms the designator 520 upon the control object 110. In a certain embodiment, the NVLRC is combined with a visible ink to form the designator 520. In an alternate embodiment, the NVLRC is applied to form the designator 520 separately from the visible ink. The NVLRC designator 520 may have the same form as a visible ink designator. Alternatively, the NVLRC designator 520 may have a different form from the visible ink designator. The NVLRC reacts to non-visible light by radiating visible light. In one embodiment, the NVLRC reacts to ultraviolet light. In a certain embodiment, the NVLRC is Inter-Glow Ultraviolet Ink manufactured by the International Ink Company of Gainesville, Ga.

The NVLS 510 directly radiates the NVLRC. The NVLRC reacts to the non-visible light from the NVLS 510 by radiating visible light. The radiated visible light demarks the control object 110. In addition, the radiated visible light demarks one or more control objects 110 with uniform illumination. The radiated visible light may be of a low intensity to reduce glare and distractions to the user and nearby people.

In one embodiment, the NVLS is an ultraviolet light source. In a certain embodiment, the NVLS is an ultraviolet light emitting diode. The light emitting diode may be a NS370D-BULA ultraviolet light emitting diode manufactured by Nitride Semiconductors Co., Ltd. of Naruto, Japan.

In one embodiment, the NVLS 510 is mounted on the NVLS mount 525. The NVLS mount 525 may be physically separated from the I/O device 505. In an alternate embodiment, the NVLS mount 525 is a positioning stalk connected to the I/O device 505. The non-visible-light-demarking system 500 demarks a control object 110 in low-light environments while reducing the glare and distraction of the demarking illumination. In addition, the non-visible-light-demarking system 500 demarks one or more control objects 110 with uniform illumination.

FIG. 6 depicts one embodiment of a non-visible-light-demarking device 600 of the present invention. The non-visible-light-demarking device 600 demarks a control object 110 with a direct NVLS 510. The non-visible-light-demarking device 600 includes one or more control objects 110, a NVLS 510, and a bezel 605. The non-visible-light-demarking device 600 is depicted as a notebook computer, but any form of I/O device 505 may be used including but not limited to computers, computer keyboards, personal digital assistants, controllers, telephones, audio equipment, and cameras.

The NVLS 510 is integral to the non-visible-light-demarking device 600. In one embodiment, the NVLS 510 is integrated in the bezel 605 of the non-visible light-demarking device 600. The control object 110 resides on the non-visible-light-demarking device 600. A NVLRC is applied to the control object 110. The NVLS 510 radiates the NVLRC, demarking the control object 110. The integrated NVLS 510 increases the convenience of transporting and using the NVLS 510. In one embodiment, a larger effective quantity of the NVLRC is applied to the control object 110a further from the NVLC 510 than is applied to the control object 110b nearer the NVLC 510. The non-visible-light-demarking device 600 demarks the control object 110 with uniform brightness and reduced glare.

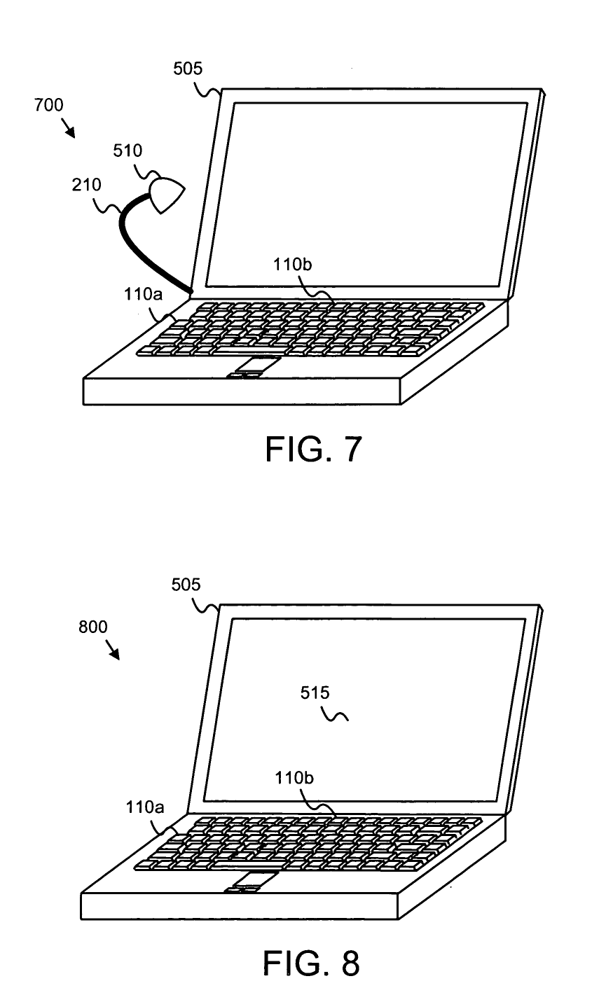

FIG. 7 illustrates one embodiment of a movable NVLS 700 of the present invention. The movable NVLS 700 positions a NVLS 510 connected to an I/O device 515 to demark the I/O device 515 control objects 110. The movable NVLS 700 includes an I/O device 505 with one or more control objects 110, a positioning stalk 210, and a NVLS 510. The I/O device 505 is depicted as a notebook computer, but any form of I/O device 505 may be used including but not limited to computers, computer keyboards, personal digital assistants, controllers, telephones, and cameras.

In one embodiment, the positioning stalk 210 positions the NVLS 510 relative to the I/O device 505. A NVLRC is applied to the control object 110. The positioned NVLS 510 radiates the NVLRC, demarking the control object 110. A user may position the NVLS 510 to adjust the radiated visible light of the NVLRC. The user may also disconnect the NVLS 510 from the I/O device 505 for convenient transportation and storage. The movable NVLS 700 provides the user flexibility in the positioning of the NVLS 510.

FIG. 8 depicts one embodiment of a NLVS display 800 in accordance with the present invention. The NLVS display 800 radiates a NVLRC applied to a control object 110 with non-visible light radiated from the display 515. The NVLS display 800 includes one or more control objects 110, an I/O device 505, and a display 515.

The display 515 radiates both visible and non-visible light. The non-visible light radiates a NVLRC applied to the control object 110, demarking the control object 110. In one embodiment, the display 515 includes a light source that radiates non-visible and visible light. In an alternate embodiment, the display 515 includes a visible light source and a NVLS 510. The NVLS 510 may radiate whenever the visible light source radiates. Alternatively, the NVLS 510 may be activated separately from the visible light source. In a certain embodiment, the display 515 includes a filter. The filter may pass selected wavelengths of non-visible light. The NLVS display 800 employs the display 515 as the NVLS 510 for radiating the NVLRC.

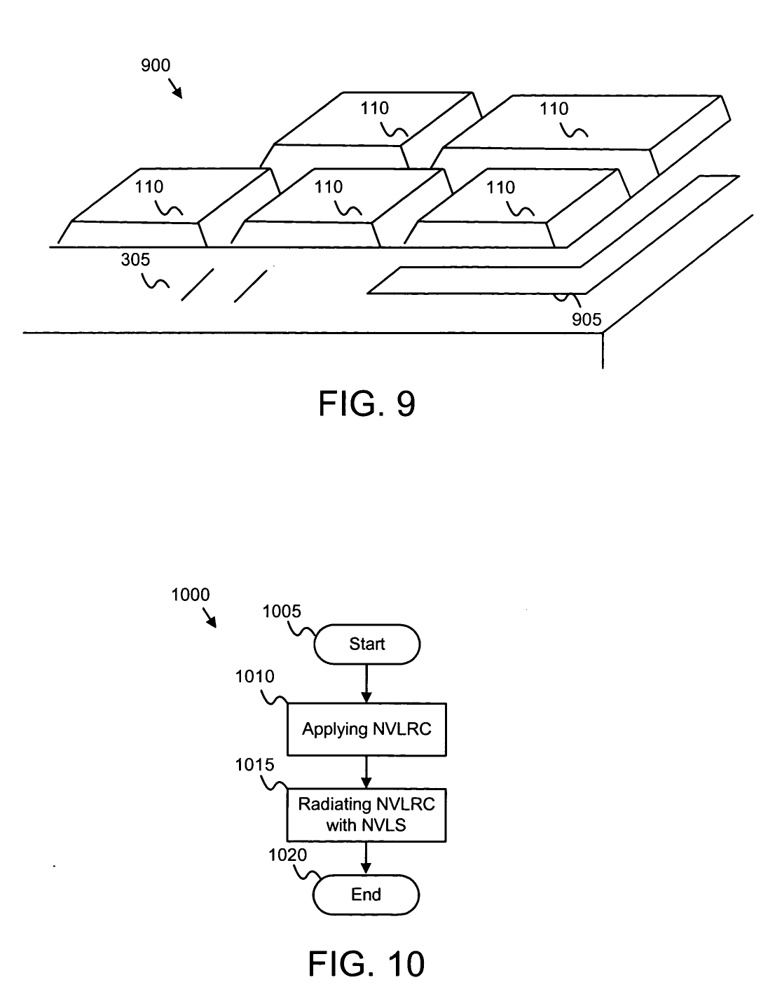

FIG. 9 illustrates one embodiment of a control area delineator 900 of the present invention. The control area delineator 900 demarks control objects 110 arranged on a control panel 305. The control area delineator 900 includes a control panel 305, a NVLRC control delineator 905, and one or more control objects 110.

The control object 110 resides on the control panel 305. The NVLRC control delineator 905 is positioned to demark the position of the control object 110. In one embodiment, a NVLRC is applied to the control panel 305 to form the NVLRC control delineator 905. In an alternate embodiment, the NVLRC is applied to a matrix material. The matrix material is adhered to the control panel 305. The control area delineator 900 demarks the position of the control object 110 as the NVLRC control delineator 905 is radiated with non-visible light from a NVLS 510 (not shown).

FIG. 10 is a flow chart diagram illustrating one embodiment of a non-visible light demarking process 1000 in accordance with the present invention. The non-visible light demarking process 1000 demarks control objects 110 by radiating a NVLRC from a NVLS 510. The non-visible light demarking process 1000 starts 1005 and applies 1010 the NVLRC to the control object 110. In one embodiment, the NVLRC forms a designator 520 on the control object 110. The non-visible light demarking process 1000 radiates 1015 the NVLRC with non-visible light. The non-visible light activates the NVLRC, and the NVLRC radiates visible light, illuminating the NVLRC and demarking the control object 110. The NVLRC radiated visible light is of low intensity, reducing the glare and distraction to the user and nearby people. In addition, the NVLRC radiated light also has a high contrast in the low-light environment, allowing the control object 110 to be identified. The NVLRC radiated light also appears more uniform across one or more control objects 110 than the illumination from a visible light source. The non-visible light demarking process 1000 terminates 1020. The non-visible light demarking process 1000 illuminates the NVLRC of the control object 110, demarking the control object 110 in a low-light environment with reduced glare and increased contrast, and uniform brightness.

The present invention demarks one or more control objects 110 in a low-light environment in a uniform manner. In addition, the present invention reduces the glare and increases the contrast and effective brightness from illuminating the NVLRC of the control object 110. The present invention also reduces the distraction to a user and to nearby people from demarking the control object 110. The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. An apparatus for demarking a control object, the apparatus comprising:
a compound applied to a control object, the compound configured to react to non-visible light by radiating visible light; and
a non-visible light source configured to directly radiate the compound.

2. The apparatus of claim 1, wherein the non-visible light source is an ultraviolet light source.

3. The apparatus of claim 2, wherein the ultraviolet light source is an ultraviolet light emitting diode.

4. The apparatus of claim 2, wherein the compound is an ultraviolet light reactive compound.

5. The apparatus of claim 1, wherein the non-visible light source are non-visible wavelengths of a display light source.

6. The apparatus of claim 1, wherein the compound is applied to a control delineator configured to demark the control object.

7. The apparatus of claim 1, wherein the compound is combined with a visible ink compound to form a designator.

8. The apparatus of claim 1, wherein the compound forms a designator upon the control object.

9. The apparatus of claim 8, wherein the designator formed by the compound differs from a visible designator.

10. An I/O device for use in a low-light environment, the I/O device comprising:
a control object;
a compound applied to the control object, the compound reactive to non-visible light, wherein the compound reacts to non-visible light by radiating visible light; and
a non-visible light source configured to directly radiate the compound.

11. The I/O device of claim 10, wherein the non-visible light source is an ultraviolet light source.

12. The I/O device of claim 11, wherein the ultraviolet light source is an ultraviolet light emitting diode.

13. The I/O device of claim 11, wherein the compound is an ultraviolet light reactive compound.

14. An I/O device, the I/O device comprising:
a control object;
a compound applied to the control object, the compound reactive to non-visible light, wherein the compound reacts to non-visible light by radiating visible light; and
a display configured to radiate visible light and non-visible light, wherein the non-visible light reacts the compound, demarking the control object.

15. A system for demarking a control object, the system comprising:
an I/O device configured with a control object;
a compound applied to the control object, the compound configured to react to non-visible light by radiating visible light; and
a non-visible light source configured to directly radiate the compound.

16. The system of claim 15, wherein the non-visible light source is an ultraviolet light source.

17. The system of claim 16, wherein the ultraviolet light source is an ultraviolet light emitting diode.

18. The system of claim 16, wherein the compound is an ultraviolet light reactive compound.

19. The system of claim 15, wherein the non-visible light source is integrated within the I/O device.

20. The system of claim 15, wherein the non-visible light source is disposed upon a positioning stalk in physical communication with the I/O device.

21. The system of claim 15, wherein the non-visible light source is separated from the I/O device.

22. The system of claim 21, wherein the non-visible light source consists of non-visible wavelengths emitted by a visible light source.

23. The system of claim 15, wherein the non-visible light source is a display of the I/O device.

24. A process for demarking a control object in a low-light environment, the process comprising:
applying a compound reactive to non-visible light to a control object, wherein the compound reacts to the non-visible light by radiating visible light; and
activating the compound by directly radiating the compound with a non-visible light source.

25. The process of claim 24, wherein the compound forms a designator.

26. The process of claim 24, wherein the non-visible light source is an ultraviolet light source.

27. The process of claim 26, wherein the compound is an ultraviolet light reactive compound.

28. The process of claim 26, wherein the ultraviolet light source is an ultraviolet light emitting diode.

29. An apparatus for illuminating a control object, the apparatus comprising:
means for applying a compound reactive to non-visible light to a control object, wherein the compound reacts to the non-visible light by radiating visible light; and
means for activating the compound by directly radiating the compound with a non-visible light source.

30. The apparatus of claim 29, wherein the non-visible light source is an ultraviolet light source and the compound is an ultraviolet light reactive compound.
